(19) United States
(12) Patent Application Publication
(10) Pub. No.: US 2026/0233525 A1
(43) Pub. Date: Aug. 13, 2026

(54) METHOD OF MANUFACTURING NOZZLE PLATE AND NOZZLE PLATE

(71) Applicant: SEIKO EPSON CORPORATION, Tokyo (JP)

(72) Inventors: Motoki TAKABE, SHIOJIRI-SHI (JP); Kai ITO, MATSUMOTO-SHI (JP)

(21) Appl. No.: 19/533,577

(22) Filed: Feb. 9, 2026

(30) Foreign Application Priority Data
Feb. 10, 2025 (JP) 2025-019840

(51) Int. Cl. B41J 2/16; B41J 2/14

(52) U.S. Cl. CPC B41J 2/162; B41J 2/1433; B41J 2/1628; B41J 2202/03

(57) ABSTRACT

A method of manufacturing a nozzle plate having a nozzle and made of a silicon substrate includes: a first nozzle forming step of forming a first nozzle that is open to a first surface of the nozzle plate; a curved portion forming step of forming a first curved portion in a first opening portion of the first nozzle, the first curved portion having a rounded shape in which a cross-sectional area gradually increases toward the opening, by performing an annealing treatment in which the nozzle plate is heated under a hydrogen atmosphere or an argon atmosphere; a step of forming a water-repellent film on an inner surface of the first nozzle and the first surface; and a step of removing a part of the water-repellent film by performing a plasma treatment from a second surface of the nozzle plate on the other side toward the first surface.

The present application is based on, and claims priority from JP Application Serial Number 2025-019840, filed Feb. 10, 2025, the disclosure of which is hereby incorporated by reference herein in its entirety.

### BACKGROUND

### 1. Technical Field

The present disclosure relates to a method of manufacturing a nozzle plate and a nozzle plate.

### 2. Related Art

An image forming apparatus including a liquid ejecting head that ejects liquid such as ink onto a medium such as printing paper has been proposed. The liquid ejecting head generally includes a nozzle plate in which a plurality of nozzle holes for ejecting ink droplets are formed, pressure chambers which communicate with the nozzle plate, and driving elements which apply pressure to the pressure chambers. The pressure in the pressure chambers is changed by driving the driving elements, and thereby ink droplets are ejected from the nozzle holes.

In such a liquid ejecting head, if ink adheres to the ejection surface of the nozzle plate, the ink droplets ejected from the nozzles are affected, and ejection failures such as variations in the ejection direction of ink droplets may occur. This makes it difficult for ink droplets to land at predetermined positions on the medium, and there is a possibility that image quality deteriorates. Hence, a technique is known in which a water-repellent film is provided on the ejection surface of the nozzle plate to suppress the adhesion of ink to the ejection surface. On the other hand, when the water-repellent film is excessively formed on the side wall forming the nozzle hole, there is a possibility that ejection failures such as a difficulty in ejecting ink droplets having a target amount of ink may occur.

For example, JP-A-2010-214800 discloses a nozzle plate in which a water-repellent film is provided on a peripheral edge portion of the nozzles in the ejection surface. As a method of processing the water-repellent film, first, the water-repellent film is formed on the surface of the ejection surface by a vapor deposition method or the like. Next, a protective film is attached around the nozzles. Next, portions of the water-repellent film excessively formed on the inner walls of the nozzles are removed by a plasma treatment via the protective film. Then, the protective film is removed.

In JP-A-2010-214800, the water-repellent film excessively formed on the side walls of the nozzles is removed by using a protective film. However, when the protective film is attached to the ejection surface, if alignment is not performed with high accuracy so as not to cause positional deviation, there is a possibility that the position or the amount of the remaining water-repellent film may vary for each nozzle. Hence, there is a possibility that ejection failures are likely to occur.

### SUMMARY

A method of manufacturing a nozzle plate according to an aspect of the present disclosure is a method of manufacturing a nozzle plate having a nozzle and made of a silicon substrate, the method including: a first nozzle forming step of forming a first nozzle that is open to a first surface of the nozzle plate on one side; a curved portion forming step of forming a first curved portion in a first opening portion of the first nozzle that is open to the first surface, the first curved portion having a rounded shape in which a cross-sectional area gradually increases toward the opening, by performing an annealing treatment in which the nozzle plate is heated under a hydrogen atmosphere or an argon atmosphere; a step of forming a water-repellent film on an inner surface of the first nozzle and the first surface of the nozzle plate; and a step of removing a part of the water-repellent film by performing a plasma treatment from a second surface of the nozzle plate on the other side toward the first surface.

A method of manufacturing a nozzle plate according to an aspect of the present disclosure is a method of manufacturing a nozzle plate having a nozzle and made of a silicon substrate, the method including: a first nozzle forming step of forming a first nozzle that is open to a first surface of the nozzle plate on one side; a second nozzle forming step of forming a second nozzle that is open to a second surface of the nozzle plate on the other side and is connected to the first nozzle; a curved portion forming step of forming a first curved portion in a first opening portion of the first nozzle that is open to the first surface, the first curved portion having a rounded shape in which a cross-sectional area gradually increases toward the opening, and a second curved portion having a rounded shape in which a cross-sectional area gradually increases from the first nozzle toward the second nozzle in a connection portion between the first nozzle and the second nozzle by performing an annealing treatment in which the nozzle plate is heated under a hydrogen atmosphere or an argon atmosphere; a step of forming a water-repellent film on inner surfaces of the first nozzle and the second nozzle and the first surface; and a step of removing a part of the water-repellent film by performing a plasma treatment from the second nozzle toward the first nozzle.

A nozzle plate according to an aspect of the present disclosure is a nozzle plate having a nozzle and made of a silicon substrate, the nozzle plate including a first nozzle that is open to a first surface of the nozzle plate on one side, in which the first nozzle includes a first curved portion in a first opening portion that is open to the first surface, the first curved portion having a rounded shape in which a cross-sectional area gradually increases toward the opening, and the first curved portion is provided with a water-repellent film.

### BRIEF DESCRIPTION OF THE DRAWINGS

FIG. 1 is a schematic view illustrating the configuration of an image forming apparatus according to a first embodiment.

FIG. 2 is an exploded perspective view of a liquid ejecting head illustrated in FIG. 1.

FIG. 3 is a cross-sectional view of a part of the liquid ejecting head illustrated in FIG. 1.

FIG. 4 is an enlarged view of a diaphragm and piezoelectric elements illustrated in FIG. 3.

FIG. 5 is an enlarged view of the vicinity of a nozzle of a nozzle plate illustrated in FIG. 3.

FIG. 6 illustrates the vicinity of a modification of the nozzle illustrated in FIG. 5.

FIG. 7 is an enlarged view of a first nozzle of the nozzle illustrated in FIG. 5.

FIG. 8 is a flowchart of a method of manufacturing the nozzle plate of the first embodiment.

FIGS. 9A to 9C are diagrams for explaining the method of manufacturing the nozzle plate in FIG. 8.

FIGS. 10A and 10B are diagrams for explaining the method of manufacturing the nozzle plate in FIG. 8.

FIG. 11 is a cross-sectional view of the vicinity of a nozzle of a second embodiment.

FIG. 12 is a flowchart of a method of manufacturing the nozzle plate of the second embodiment.

FIGS. 13A to 13C are diagrams for explaining the method of manufacturing the nozzle plate in FIG. 12.

FIGS. 14A and 14B are diagrams for explaining the method of manufacturing the nozzle plate in FIG. 12.

### DESCRIPTION OF EMBODIMENTS

Hereinafter, embodiments according to the present disclosure will be described with reference to the accompanying drawings. In the drawings, the dimension or scale of each portion differs from the actual dimension or scale as appropriate, and some portions are schematically illustrated for easy understanding. In addition, the scope of the present disclosure is not limited to these embodiments unless it is noted in the following description that the present disclosure is limited to them. In addition, the phrase "an element β on or above an element γ" is not limited to a configuration in which the element γ is in direct contact with the element β, and also includes a configuration in which the element γ is not in direct contact with the element β. The phrase "the element α and the element β are stacked" means that the element α and the element β need only to be arranged in an up-down direction, and the element α and the element β are not limited to being in direct contact with each other.

### 1. First Embodiment

### 1-1. Overall Configuration of Image Forming Apparatus 100

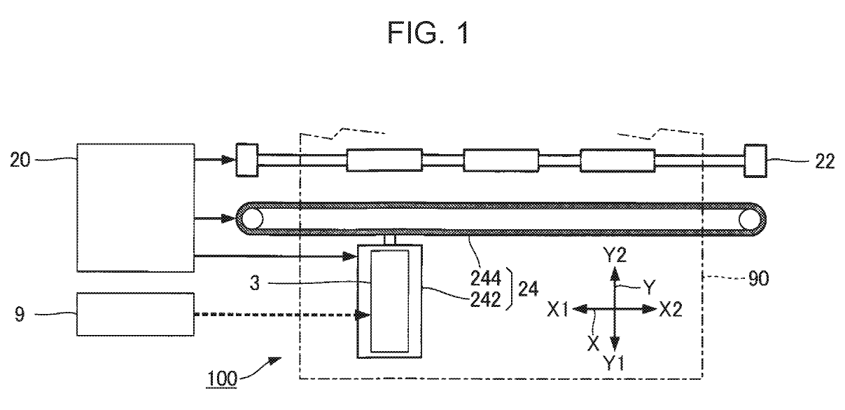

FIG. 1 is a schematic view illustrating the configuration of an image forming apparatus 100 according to a first embodiment. Hereinafter, for convenience of description, the description will be made by appropriately using an X-axis, a Y-axis, and a Z-axis which are orthogonal to one another. In addition, one direction along the X-axis is referred to as an X1 direction, and a direction opposite to the X1 direction is referred to as an X2 direction. Similarly, one direction along the Y-axis is referred to as a Y1 direction, and a direction opposite to the Y1 direction is referred to as a Y2 direction. One direction along the Z-axis is referred to as a Z1 direction, and a direction opposite to the Z1 direction is referred to as a Z2 direction. Viewing in a direction along the Z-axis will be referred to as a "plan view". The Z-axis is typically a vertical axis. The Z2 direction corresponds to an upper side, and the Z1 direction corresponds to a lower side. However, the Z-axis is not limited to the vertical axis. The X-axis, the Y-axis, and the Z-axis are typically orthogonal to each other, but are not limited thereto, and need only to intersect each other at an angle within a range of, for example, 80° or more and 100° or less.

The image forming apparatus 100 illustrated in FIG. 1 is an ink jet printing apparatus that ejects ink, which is an example of liquid, onto a medium 90. The medium 90 is typically printing paper, but a printing target of an appropriate material such as a resin film or a cloth is used as the medium 90. As illustrated in FIG. 1, a liquid container 9 that stores ink is included in the image forming apparatus 100. For example, a cartridge attachable to and detachable from the image forming apparatus 100, a bag-shaped ink pack formed of a flexible film, or an ink tank that can be replenished with ink is used as the liquid container 9.

The image forming apparatus 100 includes a control unit 20, a medium transport mechanism 22, a moving mechanism 24, and a liquid ejecting head 3. The control unit 20 includes, for example, one or a plurality of processing circuits such as a central processing unit (CPU) or a field programmable gate array (FPGA) and one or a plurality of memory circuits such as a semiconductor memory, and integrally controls the elements of the image forming apparatus 100.

The medium transport mechanism 22 transports the medium 90 in a direction along the Y-axis under the control of the control unit 20. The moving mechanism 24 reciprocates the liquid ejecting head 3 along the X-axis under the control of the control unit 20. The moving mechanism 24 includes a substantially box-shaped transport member 242 housing the liquid ejecting head 3, and a transport belt 244 to which the transport member 242 is fixed. A configuration in which a plurality of liquid ejecting heads 3 are mounted on the transport member 242 or a configuration in which the liquid container 9 is mounted on the transport member 242 together with the liquid ejecting head 3 can also be employed.

The liquid ejecting head 3 ejects the ink supplied from the liquid container 9 onto the medium 90 from a plurality of nozzles under the control of the control unit 20. An image is formed on a surface of the medium 90 by each liquid ejecting head 3 ejecting ink droplets onto the medium 90 in parallel with the transport of the medium 90 by the medium transport mechanism 22 and the repeated reciprocation of the transport member 242.

The image forming apparatus 100 is of a serial head type in which the liquid ejecting head 3 reciprocates on or above the medium 90. However, the image forming apparatus 100 may be of a line head type in which the liquid ejecting head 3 is fixed.

### 1-2. Overall Configuration of Liquid Ejecting Head 3

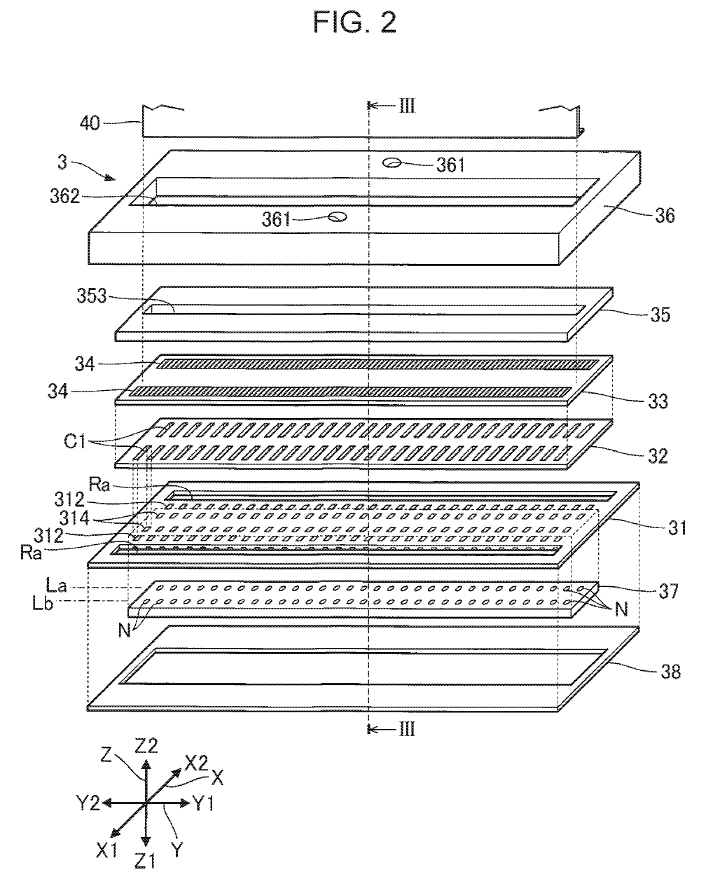

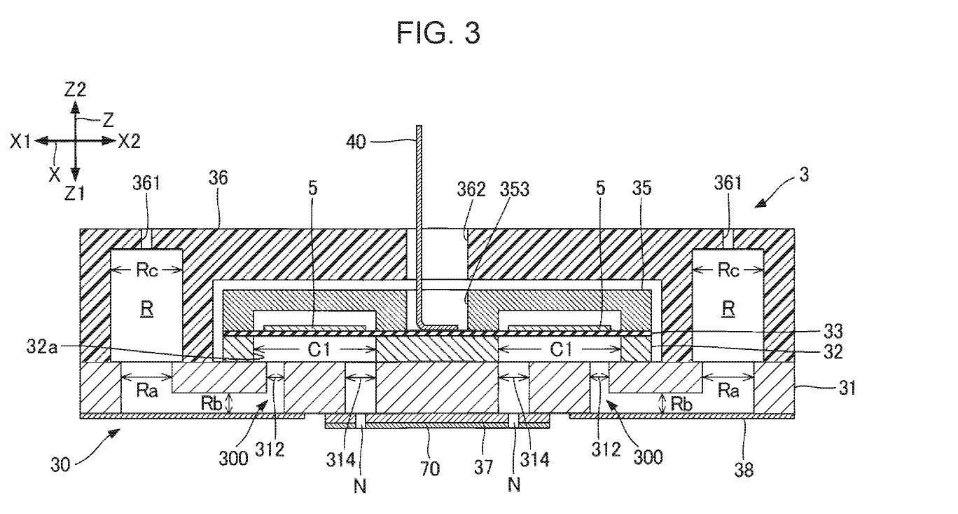

FIG. 2 is an exploded perspective view of the liquid ejecting head 3 illustrated in FIG. 1. FIG. 3 is a cross-sectional view of a part of the liquid ejecting head 3 illustrated in FIG. 1 taken along the line III-III in FIG. 2. The cross section illustrated in FIG. 3 is a cross section parallel to the X-Z plane. Note that the Z-axis is parallel to the direction of ink ejected by the liquid ejecting head 3.

As illustrated in FIG. 2, the liquid ejecting head 3 includes a plurality of nozzles N arranged along the Y-axis. The nozzles N of the first embodiment are sectioned into a first row La and a second row Lb, which are provided in parallel spaced apart from each other along the X-axis. Each of the first row La and the second row Lb is a set of a plurality of nozzles N linearly arranged along the Y-axis. The liquid ejecting head 3 has a structure in which elements related to each nozzle N in the first row La and elements related to the corresponding nozzle N in the second row Lb are disposed substantially symmetric with respect to a plane. In the following description, elements corresponding to the first row La will be mainly described, and the description of elements corresponding to the second row Lb will be omitted as appropriate.

As illustrated in FIGS. 2 and 3, the liquid ejecting head 3 includes a flow-path forming substrate 31, a pressure chamber substrate 32, a diaphragm 33, a nozzle plate 37, a vibration absorber 38, a plurality of piezoelectric elements 5, a sealing member 35, a housing portion 36, and a wiring substrate 40. Each of the flow-path forming substrate 31, the pressure chamber substrate 32, the diaphragm 33, the nozzle plate 37, the vibration absorber 38, the sealing member 35, and the housing portion 36 is a plate-shaped member elongated along the Y-axis. The nozzle plate 37, the flow-path forming substrate 31, the pressure chamber substrate 32, the diaphragm 33, and the sealing member 35 are arranged in this order in the Z2 direction.

The nozzle plate 37 is a plate-shaped member in which the plurality of nozzles N are formed. Each of the nozzles N is a circular through hole through which ink is ejected. The nozzle plate 37 is joined to the surface of the flow-path forming substrate 31 facing the Z1 direction with, for example, an adhesive. A water-repellent film 70 is provided on the lower surface of the nozzle plate 37. The water-repellent film 70 is provided to prevent ink from adhering to the lower surface of the nozzle plate 37. The water-repellent film 70 contains, for example, a fluorine-containing material having water repellency. The water repellency includes ink repellency. In other words, the term "water repellency" means the ability to repel not only water but also ink. Therefore, the term "water repellency" refers to the ability to repel not only water-based ink but also oil-based ink containing an organic solvent.

The flow-path forming substrate 31 forms flow paths through which ink flows. Specifically, in the flow-path forming substrate 31, a space Ra, a relay liquid chamber Rb, a plurality of supply flow paths 312, and a plurality of communication flow paths 314 are formed on each side. The space Ra is an opening formed in an elongated shape along the Y-axis. Each of the supply flow paths 312 and the communication flow paths 314 is a through hole formed for the corresponding nozzle N. Each of the communication flow paths 314 overlaps one corresponding nozzle N in a plan view when viewed from the Z1 direction. The relay liquid chamber Rb is a space formed in an elongated shape along the Y-axis extending along the plurality of nozzles N, and connects the space Ra to the supply flow paths 312. The pressure chamber substrate 32 is joined to the surface facing the Z2 direction of the flow-path forming substrate 31 mentioned above with an adhesive.

A plurality of pressure chambers C1 are formed in the pressure chamber substrate 32. The ink to be ejected from the nozzles N is stored in the pressure chambers C1. The pressure chambers C1 are spaces that are positioned between the nozzle plate 37 and the diaphragm 33 and are formed by inner wall surfaces 32a of the pressure chamber substrate 32. One pressure chamber C1 is formed for each nozzle N. Each pressure chamber C1 is an elongated space extending in the X1 direction. The plurality of pressure chambers C1 are arranged along the Y-axis. Each pressure chamber C1 communicates with the corresponding communication flow path 314 and supply flow path 312. Therefore, the pressure chamber C1 communicates with the nozzle N via the communication flow path 314, and communicates with the space Ra via the supply flow path 312 and the relay liquid chamber Rb.

The nozzle plate 37, the flow-path forming substrate 31, and the pressure chamber substrate 32 are manufactured by processing a silicon (Si) substrate using, for example, a semiconductor manufacturing technique such as photolithography and etching. However, known materials and manufacturing methods can be appropriately employed to manufacture the nozzle plate 37, the flow-path forming substrate 31, and the pressure chamber substrate 32.

The diaphragm 33 is connected to a surface of the pressure chamber substrate 32 on the opposite side from the flow-path forming substrate 31. The diaphragm 33 is disposed on or above the pressure chambers C1 and is elastically deformable. The diaphragm 33 is a plate-shaped member formed in a rectangular shape elongated along the Y-axis in a plan view. The diaphragm 33 and the pressure chamber substrate 32 may be integrally formed, or may be separately formed and joined to each other with an adhesive or the like.

The piezoelectric elements 5 are formed on the surface of the diaphragm 33 opposite to the pressure chambers C1. One piezoelectric element 5 is provided for each pressure chamber C1. The piezoelectric element 5 has an elongated shape along the X-axis in a plan view. The piezoelectric elements 5 are driving elements that apply pressure to the ink in the pressure chambers C1.

The sealing member 35 is joined to the diaphragm 33 with, for example, an adhesive. The sealing member 35 is a structure that protects the piezoelectric elements 5 and that reinforces the mechanical strength of the pressure chamber substrate 32 and the diaphragm 33. In the sealing member 35, recesses are formed on the surface facing the diaphragm 33. The piezoelectric elements 5 are housed inside the recesses. The sealing member 35 has a space 353 that the wiring substrate 40 passes through.

The housing portion 36 is joined to the flow-path forming substrate 31 with, for example, an adhesive. The housing portion 36 is a case for storing the ink to be supplied to the pressure chambers C1. The housing portion 36 is formed by injection molding of a resin material, for example. Spaces Rc, supply ports 361, and a space 362 are formed in the housing portion 36. The supply ports 361 are passages through which ink is supplied from the liquid container 9, and communicate with the spaces Rc. The spaces Rc communicate with the spaces Ra in the flow-path forming substrate 31. The spaces formed by the spaces Rc and the spaces Ra function as liquid storage chambers R that store the ink to be supplied to the pressure chambers C1. The ink that has been supplied from the liquid container 9 and passed through the supply ports 361 is stored in the liquid storage chambers R. On each side, the ink stored in the liquid storage chamber R flows through the relay liquid chamber Rb respectively into the supply flow paths 312 and is supplied in parallel to the plurality of pressure chambers C1. The space 362 overlaps the space 353 of the sealing member 35 in a plan view. The wiring substrate 40 passes through the space 353 and the space 362.

The wiring substrate 40 is connected to the diaphragm 33. The wiring substrate 40 is a mounted component on which a plurality of wiring lines for electrically connecting the control unit 20 and the liquid ejecting head 3 are formed. For example, a flexible substrate such as a flexible printed circuit (FPC) or a flexible flat cable (FFC) is preferably employed as the wiring substrate 40. Drive voltages and a reference voltage for driving the piezoelectric elements 5 are supplied from the wiring substrate 40 to the piezoelectric elements 5.

The vibration absorber 38 is joined to the surface of the flow-path forming substrate 31 facing the Z1 direction with, for example, an adhesive. The vibration absorber 38 is a flexible film forming wall surfaces of the spaces Ra and absorbs pressure fluctuation of the ink in the liquid storage chambers R.

In the liquid ejecting head 3, when each piezoelectric element 5 is bent by application of a voltage, the diaphragm 33 is bent in a direction in which the volume of the pressure chamber C1 decreases, that is, vibrates. Thus, the pressure in the pressure chamber C1 changes, and the ink inside the pressure chamber C1 is ejected from the nozzle N. After the ink ejection, the piezoelectric element 5 returns to its original position.

Although the liquid ejecting head 3 includes all of the elements illustrated in FIG. 3, the liquid ejecting head 3 is not limited to including all of the elements, and may further include additional elements.

### 1-3. Diaphragm 33 and Piezoelectric Elements 5

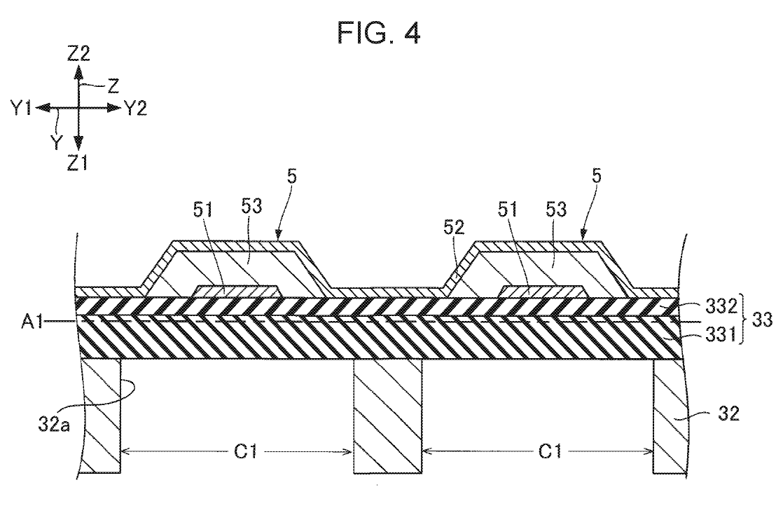

FIG. 4 is an enlarged view illustrating the diaphragm 33 and the piezoelectric elements 5 illustrated in FIG. 3. The cross section illustrated in FIG. 4 is a cross section parallel to the Y-Z plane.

As illustrated in FIG. 4, each piezoelectric element 5 is mainly formed of a lower electrode 51, a piezoelectric layer 53, and an upper electrode 52. The lower electrode 51, the piezoelectric layer 53, and the upper electrode 52 are stacked in a direction along the Z-axis, which is the stacking direction.

The lower electrode 51 is provided on or above the diaphragm 33. The lower electrode 51 is an individual electrode provided for each piezoelectric element 5. A variable drive voltage is applied to the lower electrode 51. The lower electrode 51 has an elongated shape along the X-axis. A plurality of the lower electrodes 51 are disposed spaced apart from each other along the Y-axis. The lower electrode 51 contains a conductive material such as platinum (Pt), for example. The thickness of the lower electrodes 51 along the Z-axis is not particularly limited and is, for example, 50 nm or more and 120 nm or less.

The piezoelectric layer 53 is provided on or above the lower electrodes 51. The piezoelectric layer 53 is, for example, a strip-shaped dielectric film that is continuous along the Y-axis across the plurality of piezoelectric elements 5, and includes a plurality of cutouts so as to be separated for each piezoelectric element 5. The piezoelectric layer 53 is made of a piezoelectric material having a perovskite crystal structure. Examples of the piezoelectric material include lead titanate (PbTiO₃), lead zirconate titanate (PZT: Pb(Zr,Ti)O₃), lead zirconate (PbZrO₃), lead lanthanum titanate ((Pb,La)TiO₃), lead lanthanum zirconate titanate ((Pb,La)(Zr,Ti)O₃), lead zirconate titanate niobate (Pb(Zr,Ti,Nb)O₃), lead zirconate titanate magnesium niobate (Pb(Zr,Ti)(Mg,Nb)O₃), and potassium sodium niobate (KNN). The piezoelectric layer 53 may contain small amounts of other elements such as impure substances. The thickness of the piezoelectric layer 53 along the Z-axis is not particularly limited, and is, for example, 300 nm or more and 1500 nm or less.

The upper electrode 52 is provided on or above the piezoelectric layer 53. The upper electrode 52 is a strip-shaped common electrode extending along the Y-axis so as to be continuous across the piezoelectric elements 5. A constant reference voltage is applied to the upper electrode 52. The upper electrode 52 contains a conductive material such as iridium (Ir), for example. The thickness of the upper electrode 52 along the Z-axis is not particularly limited, and is, for example, 50 nm or more and 120 nm or less.

A voltage corresponding to the difference between the reference voltage applied to the upper electrode 52 and the drive voltage corresponding to the ejection amount supplied to the lower electrode 51 is applied to the piezoelectric layer 53. When the voltage is applied between the lower electrode 51 and the upper electrode 52, the piezoelectric layer 53 deforms, so that the piezoelectric element 5 bends, that is, vibrates.

The diaphragm 33 vibrates by driving the piezoelectric element 5. In the shown example, the diaphragm 33 includes a stacked material including a first vibration layer 331 and a second vibration layer 332. The first vibration layer 331 is in contact with the pressure chamber substrate 32. The second vibration layer 332 is disposed on or above the first vibration layer 331. The first vibration layer 331 is formed of an elastic material such as silicon oxide (SiOₓ). The second vibration layer 332 is formed of an insulating material such as zirconium oxide (ZrOₓ). The first vibration layer 331 is formed by, for example, thermally oxidizing a portion of the pressure chamber substrate 32. The second vibration layer 332 is formed by, for example, a known film forming technique such as sputtering. The diaphragm 33 may be formed of one layer or may include three or more layers.

### 1-4. Nozzle Plate 37

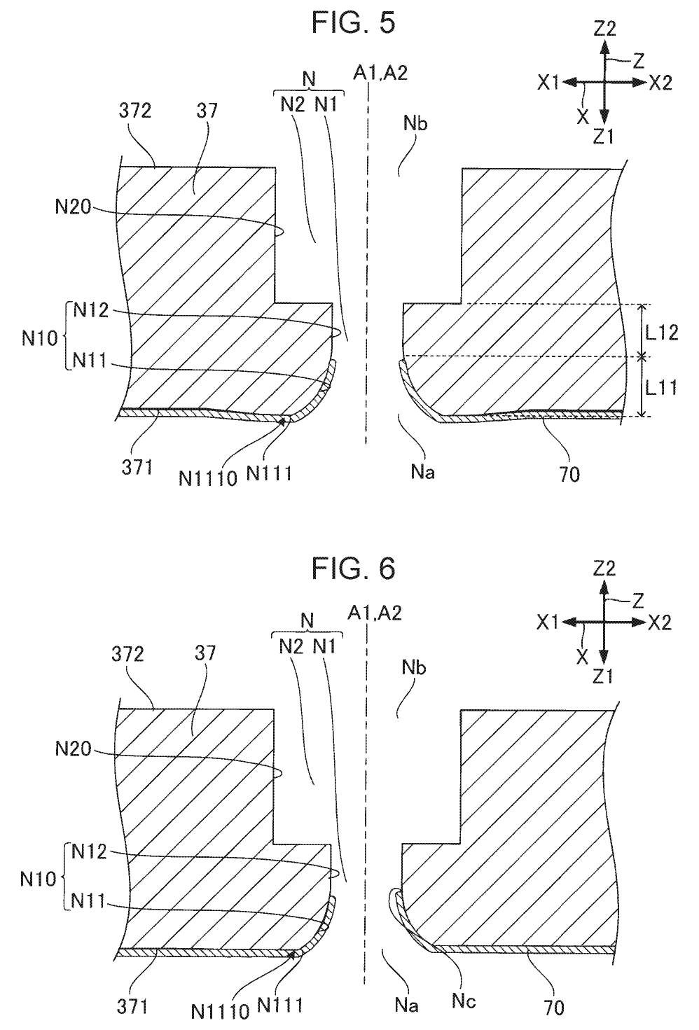

FIG. 5 is an enlarged view of the vicinity of a nozzle N in the nozzle plate 37 illustrated in FIG. 3.

The nozzle plate 37 illustrated in FIG. 5 is formed of a silicon (Si) substrate. The nozzle plate 37 has a first surface 371 on one side and a second surface 372 on the other side. Each of the first surface 371 and the second surface 372 is a surface parallel to the X-Y plane. The first surface 371 is a lower surface of the nozzle plate 37 and is an ejection surface from which ink droplets are ejected through the nozzles N. The second surface 372 is an upper surface of the nozzle plate 37 and is a surface which is in contact with the flow-path forming substrate 31. The plurality of nozzles N are formed in the nozzle plate 37. In FIG. 5, a nozzle N among the plurality of nozzles N is illustrated.

The nozzle N is a through hole formed in the nozzle plate 37. The nozzle N has a first opening portion Na and a second opening portion Nb. The first opening portion Na is the end of an opening that is open to the first surface 371. The second opening portion Nb is the end of an opening that is open to the second surface 372. The second opening portion Nb is also a boundary portion between the communication flow path 314 included in the flow-path forming substrate 31 mentioned above and the nozzle N. The length along the Z-axis from the first opening portion Na to the second opening portion Nb is the total length of the nozzle N.

The nozzle N has a first nozzle N1 and a second nozzle N2. The nozzle N is a so-called two-stage nozzle. The first nozzle N1 and the second nozzle N2 are aligned in this order in the Z2 direction and are connected to each other. Each of the first nozzle N1 and the second nozzle N2 extends along the Z-axis.

The cross-sectional shape of each of the first nozzle N1 and the second nozzle N2 is circular. The axis A1 of the first nozzle N1 along the Z-axis and the axis A2 of the second nozzle N2 along the Z-axis coincide with each other. Therefore, the first nozzle N1 and the second nozzle N2 are provided coaxially. In the illustrated example, the length of the first nozzle N1 along the Z-axis is shorter than the length of the second nozzle N2 along the Z-axis, but may be longer than or equal to the length of the second nozzle N2 along the Z-axis. The cross-sectional area of the first nozzle N1 is smaller than the cross-sectional area of the second nozzle N2. Hence, compared to a case where the diameter of the nozzle N is constant, it is possible to eject fine ink droplets and to increase landing accuracy of ink droplets.

The first nozzle N1 is open to the first surface 371. The first nozzle N1 has the first opening portion Na. The cross-sectional area of the first nozzle N1 is constant from the connecting portion with the second nozzle N2 to an intermediate point toward the first opening portion Na, and gradually increases from the intermediate point to the first opening portion Na.

A side wall N10 which is an inner surface forming the first nozzle N1 has a first curved portion N11 and a region N12. The first curved portion N11 has a rounded shape in which the cross-sectional area gradually increases toward the first opening portion Na. The first curved portion N11 has a shape having a radius R. The region N12 is a portion of the side wall N10 of the first nozzle N1 excluding the first curved portion N11. The region N12 has a smaller diameter than the first curved portion N11 in the direction along the axis A1 of the first nozzle N1. In addition, the portion of the first nozzle N1 in the region N12 is a portion that is substantially related to the formation of ink droplets. The boundary portion between the region N12 and the first curved portion N11 can be regarded as an ejection opening end Nc where the meniscus related to ink droplets is formed. Since the first curved portion N11 is provided, it is possible to shorten the portion in the region N12 which is the portion of the first nozzle N1 substantially related to the formation of ink droplets. Therefore, it is possible to increase the ejection accuracy of ink droplets.

The second nozzle N2 is open to the second surface 372. The second nozzle N2 has the second opening portion Nb. The cross-sectional area of the second nozzle N2 is constant. A side wall N20 which is an inner surface forming the second nozzle N2 has a cylindrical shape extending along the axis A2 of the second nozzle N2.

As described above, the water-repellent film 70 is provided on the first surface 371 which is the lower surface of the nozzle plate 37. The water-repellent film 70 is also provided on the first curved portion N11 of the side wall N10 of the nozzle N. A portion of the water-repellent film 70 is provided so as to cover the first curved portion N11.

Since the water-repellent film 70 is provided on the first curved portion N11, it is possible to prevent the liquid ejected from the nozzle N from remaining in the periphery of the first opening portion Na of the nozzle N. Hence, it is possible to reduce the possibility of occurrence of ejection failures such as variations in the ejection direction of the ink droplets ejected from the nozzle N due to the liquid remaining around the first opening portion Na.

In contrast, the water-repellent film 70 is not provided in the region N12 of the side wall N10 of the nozzle N. Since the water-repellent film 70 is not provided in the region N12, it is possible to eject ink droplets having a target amount of ink. If the water-repellent film 70 is provided in the region N12, it may be difficult to eject ink droplets having a target amount of ink.

In the direction along the axis A1 of the first nozzle N1, the distal end N111 of the first curved portion N11 protrudes downward from the flat portion of the first surface 371. The flat portion is the surface parallel to the X-Y plane. The distal end N111 of the first curved portion N11 can be regarded as the periphery of the first opening portion Na.

Since the distal end N111 protrudes from the flat portion of the first surface 371, it is possible to prevent the ink droplets ejected from the nozzle N from remaining in the periphery of the first opening portion Na.

Furthermore, in the first curved portion N11, the portion that protrudes from the first surface 371, which is the surface of the nozzle plate 37, is rounded. That is, the distal end surface N1110 including the distal end N111 of the first curved portion N11 is a curved surface. Hence, since there is no corner portion from the side wall N10 to the first surface 371, there is no possibility that the liquid in the nozzle N remains at such a portion. Therefore, it is possible to reduce the possibility that liquid remains in the periphery of the first opening portion Na.

FIG. 6 illustrates the vicinity of a modification of the nozzle N illustrated in FIG. 5. As illustrated in FIG. 6, the nozzle plate 37 is not limited to having a portion protruding from the flat portion of the first surface 371. That is, the vicinity of the first opening portion Na of the first surface 371 may be a flat surface parallel to the X-Y plane.

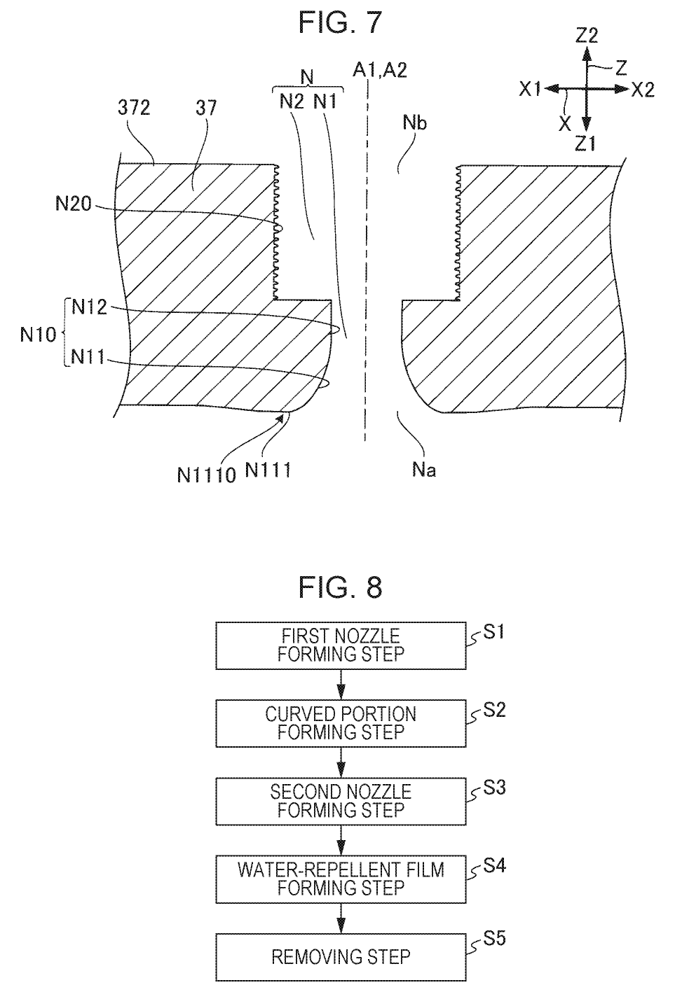

FIG. 7 is a diagram for explaining a scallop structure of the nozzle N illustrated in FIG. 5. As illustrated in FIG. 7, the side wall N20 of the second nozzle N2 has a scallop structure. In contrast, the first nozzle N1 does not have a scallop structure. In particular, the first curved portion N11 of the first nozzle N1 does not have a scallop structure. Therefore, the smoothness of the side wall N10 of the first curved portion N11 can be increased. Therefore, foreign matter is unlikely to remain in the region N12 of the first nozzle N1, and thus it is possible to suppress the occurrence of liquid clogging. In addition, since liquid droplets or foreign matter is unlikely to adhere to the first curved portion N11, it is possible to suppress deflection of the liquid ejected from the nozzle N due to liquid droplets, foreign matter, or the like.

Further, as illustrated in FIG. 5, in the direction along the axis A1 of the first nozzle N1, the length L11 of the first curved portion N11 is longer than the length L12 of the region N12. Hence, it is possible to shorten the length L12 of the portion of the first nozzle N1 in the region N12 which is the portion substantially related to the formation of ink droplets. Therefore, it is possible to increase the ejection accuracy of ink droplets.

Note that the first nozzle N1 may have a scallop structure. The side wall N20 is not limited to having a scallop structure. The length L11 may be shorter than or equal to the length L12. Note that, a scallop structure is an uneven structure and is formed, for example, when the nozzles N are formed by etching or the like.

### 1-5. Method for Manufacturing Nozzle Plate 37

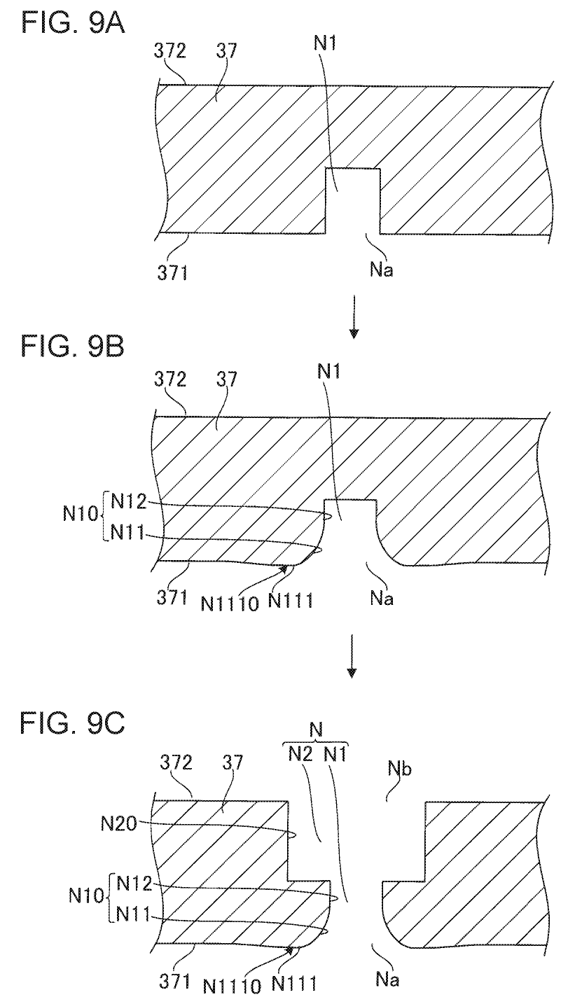

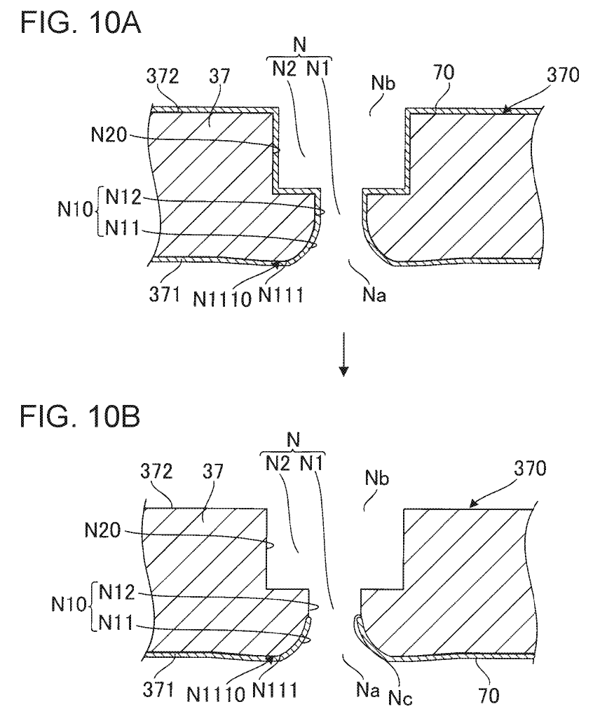

FIG. 8 is a flowchart of a method of manufacturing the nozzle plate 37 of the first embodiment. FIGS. 9A to 10B are diagrams for explaining the method of manufacturing the nozzle plate 37 in FIG. 8.

As illustrated in FIG. 8, the method of manufacturing the nozzle plate 37 includes a first nozzle forming step S1, a curved portion forming step S2, a second nozzle forming step S3, a water-repellent film forming step S4, and a removing step S5. Before these steps, the nozzle plate 37 made of a silicon substrate is first prepared. At this stage, the nozzles N are not formed in the nozzle plate 37.

As illustrated in FIG. 9A, in the first nozzle forming step S1, the first nozzle N1 which is open to the first surface 371 of the nozzle plate 37 on one side is formed. For example, a resist film having an opening corresponding to the first nozzle N1 is formed on the first surface 371, and anisotropic dry etching is performed from the first surface 371 side using a fluorine-based etching gas such as C₄F₈ and SF₆ . Thus, the first nozzle N1 is formed. The diameter of each first nozzle N1 formed in this step is constant. Therefore, each first nozzle N1 has a cylindrical shape. In this step, the entire region of the side wall N10 has a scallop structure.

Next, as illustrated in FIG. 9B, in the curved portion forming step S2, the first curved portion N11 is formed in a part of the side wall N10 by performing an annealing treatment in which the nozzle plate 37 is heated in a hydrogen atmosphere or an argon atmosphere. For example, in the annealing treatment, the nozzle plate 37 is heated to 1000° C or higher in a hydrogen atmosphere or an argon atmosphere. The heating temperature, the heating time, the flow rate of the atmospheric gas, and the like are appropriately set according to the shape of the first curved portion N11. As described above, the first curved portion N11 has a rounded shape in which the cross-sectional area gradually increases toward the first opening portion Na of the first nozzle N1 open to the first surface 371. The first curved portion N11 is formed from an intermediate position of the side wall N10 to the first opening portion Na.

In the curved portion forming step S2, the first curved portion N11 of the side wall N10 of the first nozzle N1 is smoothed. To be specific, by using annealing treatment, the scallop structure in the first curved portion N11 can be eliminated, and thus the first curved portion N11 is smoothed.

Next, as illustrated in FIG. 9C, in the second nozzle forming step S3, the second nozzle N2 which is open to the second surface 372 of the nozzle plate on the other side is formed. The second nozzle N2 is connected to the first nozzle N1. For example, a resist film having an opening corresponding to the first nozzle N1 is formed on the second surface 372, and anisotropic dry etching is performed from the second surface 372 side using a fluorine-based etching gas such as C₄F₈ and SF₆. Thus, the second nozzle N2 connected to the first nozzle N1 is formed. The diameter of the second nozzle N2 formed in this step is constant. Hence, the second nozzle N2 is cylindrical.

Next, as illustrated in FIG. 10A, in the water-repellent film forming step S4, the water-repellent film 70 is formed on the side wall N10 which is the inner face of the first nozzle N1, the side wall N20 which is the inner face of the second nozzle N2, and a surface 370 of the nozzle plate 37 including the first surface 371 and the second surface 372. The water-repellent film 70 is formed by, for example, depositing or dipping a fluorine-containing material having ink repellency. Note that a film serving as an underlying layer of the water-repellent film 70 may be formed under the water-repellent film 70.

Next, as illustrated in FIG. 10B, in the removing step S5, a part of the water-repellent film 70 is removed by performing a plasma treatment from the second surface 372 of the nozzle plate 37 toward the first surface 371. The plasma treatment is performed from the second surface 372 side. By this plasma treatment, the water-repellent film 70 remains on the first curved portion N11 and the first surface 371 in the surface 370 and the side walls N10 and N20, and the water-repellent film 70 does not remain on the other portions.

In the removing step, a protective film may be used to protect the water-repellent film 70 formed on the first surface 371, but is not essential.

As described above, the nozzle plate 37 provided with the water-repellent film 70 is formed.

As described above, in the present embodiment, the water-repellent film forming step S4 and the removing step S5 are performed after the curved portion forming step S2. In the removing step S5, a part of the water-repellent film 70 is removed by performing a plasma treatment from the second surface 372 toward the first surface 371.

The portion of the first nozzle N1 corresponding to the first curved portion N11 has a larger cross-sectional area than the portion corresponding to the region N12. Therefore, during the plasma treatment, the first curved portion N11 is hidden by the region N12, and the water-repellent film 70 on the first curved portion N11 is not removed. Therefore, it is possible to reliably leave the water-repellent film 70 in the vicinity of the first opening portion Na and also in the periphery of the ejection opening end Nc. Therefore, unlike the related art, there is no possibility that the position or the amount of the remaining water-repellent film 70 varies for each nozzle N due to the positional deviation of a protective film. That is, according to the manufacturing method of the present embodiment, since the position where the water-repellent film 70 remains is determined by the formation of the first curved portion N11, it is possible to prevent the occurrence of a region where the water-repellent film is not provided in the vicinity of the ejection opening end Nc of the nozzle N due to the positional deviation of a protective film. Therefore, it is possible to reduce the possibility of occurrence of ejection failures.

In addition, in the curved portion forming step S2, the first curved portion N11 is formed by performing an annealing treatment in which the nozzle plate 37 is heated under a hydrogen atmosphere or an argon atmosphere. By performing the annealing treatment in a hydrogen atmosphere or an argon atmosphere, the first curved portion N11 having a rounded shape in which the cross-sectional area gradually increases toward the first opening portion Na can be formed with high accuracy. The use of the annealing treatment under a hydrogen atmosphere or an argon atmosphere is preferable from the viewpoint of processing accuracy and reduction in processing time as compared with the case of using machining and laser processing. In addition, by adjusting the temperature and time of the annealing treatment, it is possible to control the radius R that determines the size of the curve of the first curved portion N11.

Further, when the first surface 371 is wiped, a wiping tool does not come into contact with the first curved portion N11, and thus the water-repellent film 70 is unlikely to be peeled off in the first curved portion N11. Therefore, the water-repellent film 70 can be reliably left in the vicinity of the first opening portion Na and also in the periphery of the ejection opening end Nc. Therefore, it is possible to reduce the possibility of occurrence of ejection failures for a long period of time.

Further, the nozzle N of the present embodiment is a two-stage nozzle having the first nozzle N1 and the second nozzle N2. The cross-sectional area of the second nozzle N2 is larger than the cross-sectional area of the portion of the first nozzle N1 in the region N12. Therefore, in the removing step S5, by performing the plasma treatment from the second surface 372 toward the first surface 371, it is possible to highly accurately remove the water-repellent film 70 formed on the side wall N20 of the second nozzle N2 and the portion of the first nozzle N1 in the region N12.

Further, as described above, in the curved portion forming step S2, the side wall N10 of the first nozzle N1 is smoothed. Hence, since foreign matter is unlikely to remain on the side wall N10 of the first nozzle N1, it is possible to suppress the occurrence of liquid clogging in the nozzle N. Therefore, it is possible to suppress the occurrence of ejection failures.

### 2. Second Embodiment

A second embodiment will be described. In the following examples, elements having the same functions as those in the first embodiment are denoted by the same reference numerals as those used in the description of the first embodiment, and detailed description thereof will be appropriately omitted.

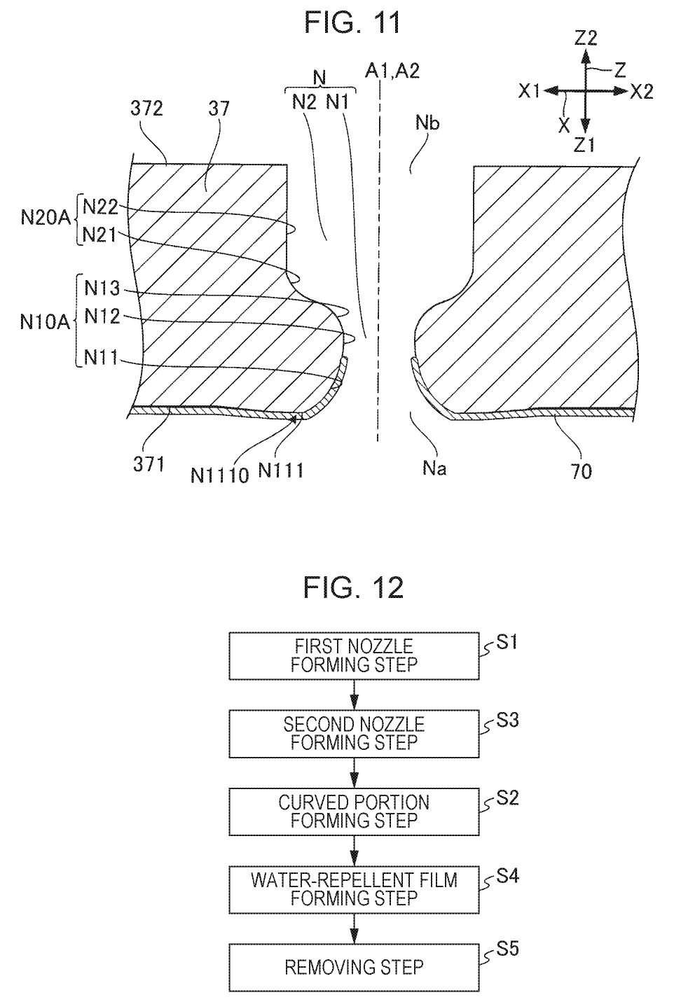

FIG. 11 is a cross-sectional view of the vicinity of a nozzle N of a nozzle plate 37A of the second embodiment. As illustrated in FIG. 11, the side wall N10A of a first nozzle N1 has a second curved portion N13. The second curved portion N13 has a rounded shape at the connecting portion between the first nozzle N1 and a second nozzle N2 in which the cross-sectional area gradually increases from the first nozzle N1 toward the second nozzle N2.

Since the second curved portion N13 is provided, it is possible to reduce the places where ink stagnates between the first nozzle N1 and the second nozzle N2. Therefore, the stability of ejection can be improved.

Further, the side wall N20A of the second nozzle N2 has a third curved portion N21 and a region N22. The region N22 has a larger diameter than the third curved portion N21 in the direction along the axis A2 of the second nozzle N2. The region N22 is a portion of the side wall N20A of the second nozzle N2 excluding the third curved portion N21. In addition, the third curved portion N21 has a rounded shape at the connecting portion between the first nozzle N1 and the second nozzle N2 in which the cross-sectional area gradually decreases toward the first nozzle N1.

Since the third curved portion N21 is provided in addition to the second curved portion N13, it is possible to reduce the places where ink stagnates between the first nozzle N1 and the second nozzle N2. Therefore, the stability of ejection can be improved.

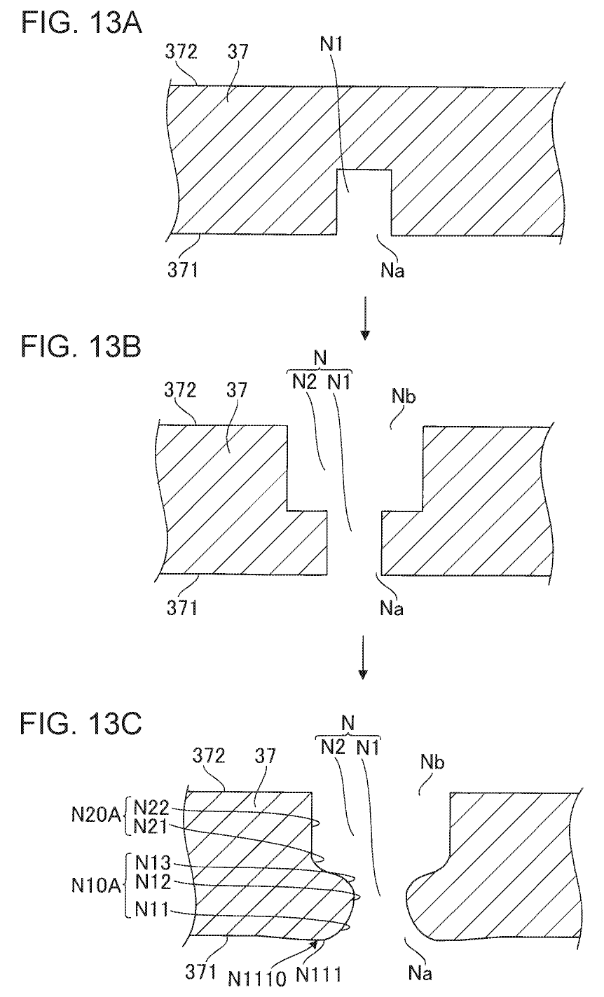

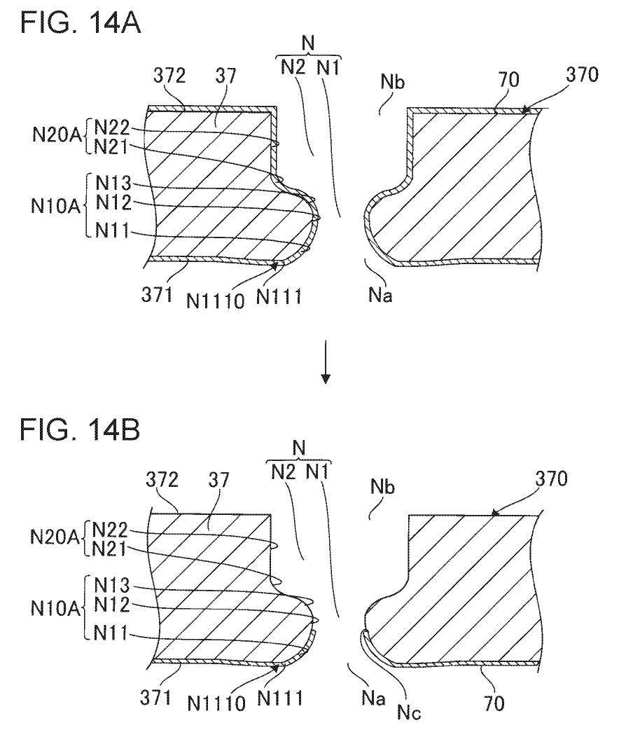

FIG. 12 is a flowchart of a method of manufacturing the nozzle plate 37A of the second embodiment. FIGS. 13A to 14B are diagrams for explaining the method of manufacturing the nozzle plate 37A in FIG. 12.

As illustrated in FIG. 12, the method of manufacturing the nozzle plate 37A of the second embodiment includes a first nozzle forming step S1, a second nozzle forming step S3, a curved portion forming step S2, a water-repellent film forming step S4, and a removing step S5. In the present embodiment, the curved portion forming step S2 is performed after the second nozzle forming step S3.

As illustrated in FIG. 13A, the first nozzle forming step S1 of the present embodiment is the same as the first nozzle forming step S1 of the first embodiment.

As illustrated in FIG. 13B, in the second nozzle forming step S3, the second nozzle N2 which is open to the second surface 372 of the nozzle plate 37A is formed. Each of the first nozzle N1 and the second nozzle N2 of the nozzle N formed through this step has a cylindrical shape.

As illustrated in FIG. 13C, in the curved portion forming step S2, the first curved portion N11 and the second curved portion N13 are formed in parts of the side wall N10A, and the third curved portion N21 is formed in a part of the side wall N20A, by performing an annealing treatment in which the nozzle plate 37A is heated in a hydrogen atmosphere or an argon atmosphere.

As illustrated in FIG. 14A, the water-repellent film forming step S4 of the present embodiment is the same as the water-repellent film forming step S4 of the first embodiment.

As illustrated in FIG. 14B, the removing step S5 of the present embodiment is the same as the removing step S5 of the first embodiment. By this step, the water-repellent film 70 remains on the first curved portion N11 and the first surface 371 in the surface 370 and the side walls N10A and N20A, and the water-repellent film 70 does not remain on the other portions.

Also in the present embodiment, similarly to the first embodiment, it is possible to reduce the possibility of occurrence of ejection failures. In addition, it is possible to reduce the places where ink stagnates between the first nozzle N1 and the second nozzle N2. Therefore, the stability of ejection can be improved.

In the curved portion forming step S2, the side wall N10A of the first nozzle N1 and the side wall N20A of the second nozzle N2 are smoothed. Hence, since foreign matter is unlikely to remain on the side wall N10A of the first nozzle N1 and the side wall N20A of the second nozzle N2, it is possible to suppress the occurrence of liquid clogging in the nozzle N. Therefore, it is possible to suppress the occurrence of ejection failures.

### 3. Modifications

The embodiments described above as examples may be modified in various ways. Specific aspects of modifications that can be applied to the embodiments described above will be described below as examples. Any two or more aspects selected from the following examples can be combined as appropriate as long as no contradiction occurs.

The "liquid ejecting head" may be a circulation type head having a so-called circulation flow path.

The "image forming apparatus" can be employed in various apparatuses such as facsimile machines and copying machines, in addition to apparatuses dedicated to printing. The applications of image forming apparatuses are not limited to printing. For example, an image forming apparatus that ejects a solution of a coloring material is used as a manufacturing apparatus that forms a color filter of a display device such as a liquid crystal display panel. An image forming apparatus that ejects a solution of a conductive material is used as a manufacturing apparatus that forms wiring or an electrode of a wiring substrate. An image forming apparatus that ejects a solution of an organic substance relating to a living body is used as, for example, a manufacturing apparatus that manufactures a biochip.

Although the present disclosure is described above based on the embodiments, the present disclosure is not limited to the above-described embodiments. In addition, the configuration of each portion of the present disclosure can be replaced with any configuration having the same function as those in the above-described embodiments, and any configuration can be added.

### 4. Appendix

For example, the following aspects can be derived from the above-described embodiments or modifications.

A method of manufacturing a nozzle plate according to a first aspect which is an example of the present disclosure is a method of manufacturing a nozzle plate having a nozzle of a liquid ejecting head and made of a silicon substrate, the method including: a first nozzle forming step of forming a first nozzle that is open to a first surface of the nozzle plate on one side; a curved portion forming step of forming a first curved portion in a first opening portion of the first nozzle that is open to the first surface, the first curved portion having a rounded shape in which a cross-sectional area gradually increases toward the opening, by performing an annealing treatment in which the nozzle plate is heated under a hydrogen atmosphere or an argon atmosphere; a step of forming a water-repellent film on an inner surface of the first nozzle and the first surface of the nozzle plate; and a step of removing a part of the water-repellent film by performing a plasma treatment from a second surface of the nozzle plate on the other side toward the first surface.

According to the first aspect, it is possible to prevent the occurrence of a portion where the water-repellent film is not attached in the ejection side opening of the nozzle due to the positional deviation of a protective film as in the related art. Therefore, it is possible to reduce the possibility of occurrence of ejection failures.

A method of manufacturing a nozzle plate according to a second aspect which is an example of the first aspect further includes: a second nozzle forming step of forming a second nozzle that is open to the second surface of the nozzle plate and is connected to the first nozzle; a step of forming the water-repellent film on the inner surface of the first nozzle, an inner surface of the second nozzle, and the first surface of the nozzle plate; and a step of removing a part of the water-repellent film by performing a plasma treatment from the second surface toward the first surface.

According to the second aspect, the water-repellent film formed on the side wall of the second nozzle and the portion of the region of the first nozzle can be removed with high accuracy.

In a method of manufacturing a nozzle plate according to a third aspect which is an example of the first or second aspect, in an axial direction of the first nozzle, a length of the first curved portion is longer than a length of a portion of the first nozzle excluding the first curved portion.

According to the third aspect, it is possible to increase the ejection accuracy of ink droplets.

A method of manufacturing a nozzle plate according to a fourth aspect which is an example of the present disclosure is a method of manufacturing a nozzle plate having a nozzle of a liquid ejecting head and made of a silicon substrate, the method including: a first nozzle forming step of forming a first nozzle that is open to a first surface of the nozzle plate on one side; a second nozzle forming step of forming a second nozzle that is open to a second surface of the nozzle plate on the other side and is connected to the first nozzle; a curved portion forming step of forming a first curved portion in a first opening portion of the first nozzle that is open to the first surface, the first curved portion having a rounded shape in which a cross-sectional area gradually increases toward the opening, and a second curved portion having a rounded shape in which a cross-sectional area gradually increases from the first nozzle toward the second nozzle in a connection portion between the first nozzle and the second nozzle by performing an annealing treatment in which the nozzle plate is heated under a hydrogen atmosphere or an argon atmosphere; a step of forming a water-repellent film on inner surfaces of the first nozzle and the second nozzle and the surface; and a step of removing a part of the water-repellent film by performing a plasma treatment from the second nozzle toward the first nozzle.

According to the fourth aspect, it is possible to prevent the occurrence of a portion where the water-repellent film is not attached in the ejection side opening of the nozzle due to the positional deviation of a protective film as in the related art. Therefore, it is possible to reduce the possibility of occurrence of ejection failures. Further, it is possible to reduce the places where liquid stagnates between the first nozzle and the second nozzle. Therefore, the stability of ejection can be improved.

In a method of manufacturing a nozzle plate according to a fifth aspect which is an example of any one of the first to fourth aspects, in the curved portion forming step, a side wall of the first nozzle is smoothed.

According to the fifth aspect, it is possible to suppress the occurrence of liquid clogging in the nozzle. Therefore, it is possible to suppress the occurrence of ejection failures.

A nozzle plate according to a sixth aspect which is an example of the present disclosure is a nozzle plate having a nozzle of a liquid ejecting head and made of a silicon substrate, the nozzle plate including a first nozzle that is open to a first surface of the nozzle plate on one side, in which the first nozzle includes a first curved portion in a first opening portion that is open to the first surface, the first curved portion having a rounded shape in which a cross-sectional area gradually increases toward the opening, and the first curved portion is provided with a water-repellent film.

According to the sixth aspect, it is possible to reduce the possibility of occurrence of ejection failures such as variations in the ejection direction of ink droplets ejected from the nozzle due to the liquid remaining around the first opening portion.

In a nozzle plate according to a seventh aspect which is an example of the sixth aspect, in an axial direction of the first nozzle, the first nozzle includes a region having a smaller diameter than the first curved portion, and the region is not provided with the water-repellent film.

According to the seventh aspect, it is possible to eject ink droplets having a target amount of ink.

A nozzle plate according to an eighth aspect which is an example of the sixth or seventh aspect further includes a second nozzle that is open to a second surface of the nozzle plate on the other side and is connected to the first nozzle, a side wall of the second nozzle has a scallop structure, and a side wall of the first nozzle does not have a scallop structure.

According to the eighth aspect, it is possible to suppress the occurrence of liquid clogging in the nozzle. Therefore, it is possible to suppress the occurrence of ejection failures. In addition, since the first curved portion is smoothed, and liquid droplets or foreign matter is unlikely to adhere to the first curved portion, it is possible to suppress deflection of the liquid ejected from the nozzle due to liquid droplets, foreign matter, or the like.

A nozzle plate according to a ninth aspect which is an example of any one of the sixth to eighth aspects further includes a second nozzle that is open to a second surface of the nozzle plate on the other side and is connected to the first nozzle, and in an axial direction of the first nozzle, a length of the first curved portion is longer than a length of a portion of the first nozzle excluding the first curved portion.

According to the ninth aspect, it is possible to increase the ejection accuracy of ink droplets.

In a nozzle plate according to a tenth aspect which is an example of any one of the sixth to ninth aspects, in an axial direction of the first nozzle, a distal end of the first curved portion protrudes from the first surface.

According to the tenth aspect, it is possible to prevent ink droplets ejected from the nozzle from remaining in the periphery of the first opening portion.

In a nozzle plate according to an eleventh aspect which is an example of the tenth aspect, in the first curved portion, a portion protruding from the first surface of the nozzle plate is rounded.

According to the eleventh aspect, it is possible to reduce the possibility that liquid remains in the periphery of the first opening portion.

A nozzle plate according to a twelfth aspect which is an example of any one of the sixth to eleventh aspects further includes: a second nozzle that is open to a second surface of the nozzle plate on the other side and is connected to the first nozzle; and a second curved portion having a rounded shape in which a cross-sectional area gradually increases from the first nozzle toward the second nozzle in a connection portion between the first nozzle and the second nozzle.

According to the twelfth aspect, it is possible to reduce the possibility of occurrence of ejection failures. Further, it is possible to reduce the places where liquid stagnates between the first nozzle and the second nozzle. Therefore, the stability of ejection can be improved.

What is claimed is:

1. A method of manufacturing a nozzle plate having a nozzle and made of a silicon substrate, the method comprising:
a first nozzle forming step of forming a first nozzle that is open to a first surface of the nozzle plate on one side;
a curved portion forming step of forming a first curved portion in a first opening portion of the first nozzle that is open to the first surface, the first curved portion having a rounded shape in which a cross-sectional area gradually increases toward the opening, by performing an annealing treatment in which the nozzle plate is heated under a hydrogen atmosphere or an argon atmosphere;
a step of forming a water-repellent film on an inner surface of the first nozzle and the first surface of the nozzle plate; and
a step of removing a part of the water-repellent film by performing a plasma treatment from a second surface of the nozzle plate on the other side toward the first surface.

2. The method of manufacturing a nozzle plate according to claim 1, further comprising:
a second nozzle forming step of forming a second nozzle that is open to the second surface of the nozzle plate and is connected to the first nozzle;
a step of forming the water-repellent film on the inner surface of the first nozzle, an inner surface of the second nozzle, and the first surface; and
a step of removing a part of the water-repellent film by performing the plasma treatment from the second surface toward the first surface.

3. The method of manufacturing a nozzle plate according to claim 1, wherein
in an axial direction of the first nozzle, a length of the first curved portion is longer than a length of a portion of the first nozzle excluding the first curved portion.

4. The method of manufacturing a nozzle plate according to claim 1, wherein, in the curved portion forming step, the nozzle plate is heated under the hydrogen atmosphere.

5. The method of manufacturing a nozzle plate according to claim 1, wherein, in the curved portion forming step, the nozzle plate is heated under the argon atmosphere.

6. A method of manufacturing a nozzle plate having a nozzle and made of a silicon substrate, the method comprising:
a first nozzle forming step of forming a first nozzle that is open to a first surface of the nozzle plate on one side;
a second nozzle forming step of forming a second nozzle that is open to a second surface of the nozzle plate on the other side and is connected to the first nozzle;
a curved portion forming step of forming a first curved portion in a first opening portion of the first nozzle that is open to the first surface, the first curved portion having a rounded shape in which a cross-sectional area gradually increases toward the opening, and a second curved portion having a rounded shape in which a cross-sectional area gradually increases from the first nozzle toward the second nozzle in a connection portion between the first nozzle and the second nozzle by performing an annealing treatment in which the nozzle plate is heated under a hydrogen atmosphere or an argon atmosphere;
a step of forming a water-repellent film on inner surfaces of the first nozzle and the second nozzle and the first surface; and
a step of removing a part of the water-repellent film by performing a plasma treatment from the second nozzle toward the first nozzle.

7. The method of manufacturing a nozzle plate according to claim 1, wherein
in the curved portion forming step, a side wall of the first nozzle is smoothed.

8. The method of manufacturing a nozzle plate according to claim 6, wherein, in the curved portion forming step, the nozzle plate is heated under the hydrogen atmosphere.

9. The method of manufacturing a nozzle plate according to claim 6, wherein, in the curved portion forming step, the nozzle plate is heated under the argon atmosphere.

10. A nozzle plate having a nozzle and made of a silicon substrate, the nozzle plate comprising
a first nozzle that is open to a first surface of the nozzle plate on one side, wherein
the first nozzle includes a first curved portion in a first opening portion that is open to the first surface, the first curved portion having a rounded shape in which a cross-sectional area gradually increases toward the opening, and
the first curved portion is provided with a water-repellent film.

11. The nozzle plate according to claim 10, wherein
in an axial direction of the first nozzle, the first nozzle includes a region having a smaller diameter than the first curved portion, and
the region is not provided with the water-repellent film.

12. The nozzle plate according to claim 10, further comprising
a second nozzle that is open to a second surface of the nozzle plate on the other side and is connected to the first nozzle, wherein
a side wall of the second nozzle has a scallop structure, and
a side wall of the first nozzle does not have a scallop structure.

13. The nozzle plate according to claim 10, further comprising
a second nozzle that is open to a second surface of the nozzle plate on the other side and is connected to the first nozzle, wherein
in an axial direction of the first nozzle, a length of the first curved portion is longer than a length of a portion of the first nozzle excluding the first curved portion.

14. The nozzle plate according to claim 10, wherein
in an axial direction of the first nozzle, a distal end of the first curved portion protrudes from the first surface.

15. The nozzle plate according to claim 14, wherein
in the first curved portion, a portion protruding from the first surface of the nozzle plate is rounded.

16. The nozzle plate according to claim 10, further comprising:
a second nozzle that is open to a second surface of the nozzle plate on the other side and is connected to the first nozzle; and
a second curved portion having a rounded shape in which a cross-sectional area gradually increases from the first nozzle toward the second nozzle in a connection portion between the first nozzle and the second nozzle.
